(19) United States
(12) Patent Application Publication
(10) Pub. No.: US 2008/0189290 A1
(43) Pub. Date: Aug. 7, 2008

(54) Method and System for Representing an Exploration of Resources Over a Communication Network

(75) Inventors: Dae Young Kim, Seoul (KR); Sang Seok Lee, Seoul (KR); Eun Sun Yun, Seoul (KR); Jung Eun Lee, Seoul (KR)

Correspondence Address: Law Office of Mark J. Spolyar, 38 Fountain Street, San Francisco, CA, 94114, US

(73) Assignee: Yahoo! Inc., a Delaware Corporation

(21) Appl. No.: 11/671,837

(22) Filed: Feb. 6, 2007

(51) Int. Cl. G06F 17/30

(52) U.S. Cl. 707/10

(57) ABSTRACT

In particular embodiments, a system and method for representing an exploration of resources over a communication network is disclosed. According to the embodiments, if a search query representing a target resource locator is received from a user, resources having links to the target resource locator are searched. Then, a data structure including a hierarchy of nodes and its graphical representation is generated for representing the resources each having a link to the target resource locator. The graphical representation may include a constellation map including a plurality of planets representing the resources each having a link to the target resource locator. Such data structure and graphical representation may be saved in a database for later retrieval. The system and method provides a user-friendly graphical representation of exploring resources linked to a target resource such as a webpage or a blog site managed by the user.

### TECHNICAL FIELD

The present disclosure generally relates to visualizing an exploration of resources linked to a particular resource over a communication network.

### BACKGROUND

Conventional web page search engines simply provide a list of links to web pages or other types of resources relevant to keyword(s) a user wants to search for, while the user actually wants to find more extensive and detailed information on the web pages.

For example, users may want to know information on web sites or other types of resources citing their own web pages such as blog sites. In this case, the users may input a search query including keyword(s) relevant to their own web pages. However, conventional web page search engines provide only a list of web pages including the keyword(s), but not any information on other web pages citing or linked to their web pages. In order to meet such users' need, Yahoo Inc. provides the Site Explore (http://siteexplorer.search.yahoo.com/) to obtain detailed information on which sites are linked to a particular target webpage. In response to a user's search query including an URL address of a certain web site, the Site Explorer provides a list of web pages citing the URL address.

However, even when using the conventional search engines such as the Site Explorer, a user may find it burdensome to input an exact URL of a target webpage. Also, it is difficult for a user to recognize the relevance of the target webpage to the searched web pages.

### SUMMARY

In certain embodiments of the present invention, a system and method for representing an exploration of resources over a communication network is disclosed. If a search query representing a target resource locator is received from a user, resources having links to the target resource locator are searched. Then, a data structure including a hierarchy of nodes and its graphical representation are generated for representing the resources each having a link to the target resource locator. Such data structure and graphical representation may be saved in a database for later retrieval.

In one embodiment, the graphical representation may include a constellation map including a plurality of planets representing the resources each having a link to the target resource locator. The sizes of the planets may be adjusted in proportion to the numbers of links to the target resource locator that corresponding resources have. Further, the planets may be represented using different colors or shapes depending on one or more attributes of the corresponding resources. The method and system in accordance with particular embodiments of the present invention provides a user with a user-friendly visualization of resources linked to a target resource such as a web page or a blog site managed by the user.

### BRIEF DESCRIPTION OF THE DRAWINGS

FIG. 1 shows a configuration of a resource exploring system in accordance with one embodiment of the present invention.

FIG. 2 depicts one example of search results provided by the search engine in accordance with one embodiment of the present invention.

FIG. 3A depicts one example of a tree data structure representing search results in accordance with one embodiment of the present invention.

FIG. 3B illustrates a method of converting a tree data structure representing search results into a graphical representation in accordance with one embodiment of the present invention.

FIG. 4 depicts one example of a graphical representation of search results provided by the visualization module in accordance with one embodiment of the present invention.

FIG. 5 describes an example of visual effect that provides a user with information which planets have the same attributes in accordance with one embodiment of the present invention.

FIG. 6 depicts one example of a graphical user interface provided by the visualization module in accordance with one embodiment of the present invention.

FIG. 7 shows a configuration of a resource exploring system including a database for storing generated constellation maps in accordance with one embodiment of the present invention.

FIG. 8 describes an example of a graphical user interface showing a constellation map together with links to the constellation maps stored by another user, in accordance with one embodiment of the present invention.

FIG. 9 describes an example of a graphical user interface provided when a user clicks one of the links to constellation maps shown in FIG. 8 in accordance with one embodiment of the present invention.

FIG. 10 illustrates a computing system architecture, which may be used to implement a system or a method according to one embodiment of the present invention.

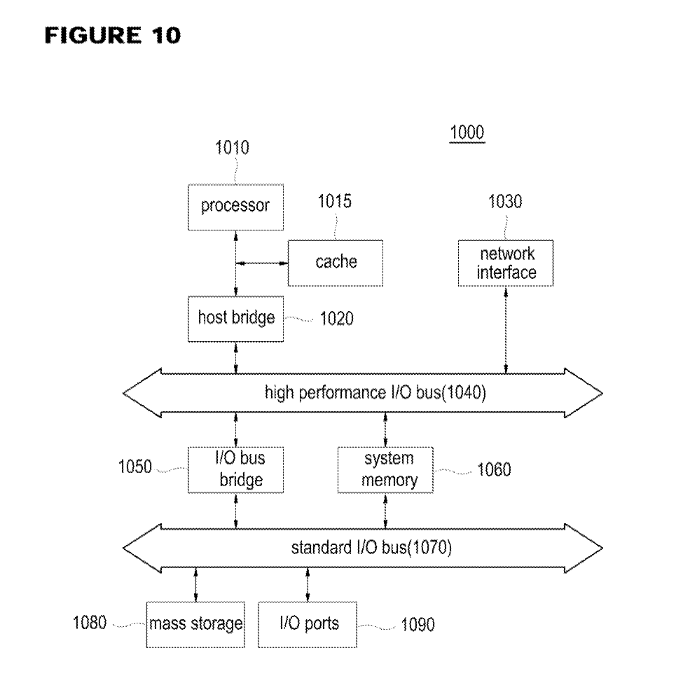

### DESCRIPTION OF EXAMPLE EMBODIMENTS

Various embodiments of the present invention will be described in detail below with reference to the accompanying drawings. It will be apparent, however, that these embodiments may be practiced without some or all of these specific details. In other instances, well known process steps or elements have not been described in detail in order not to unnecessarily obscure the description of the invention.

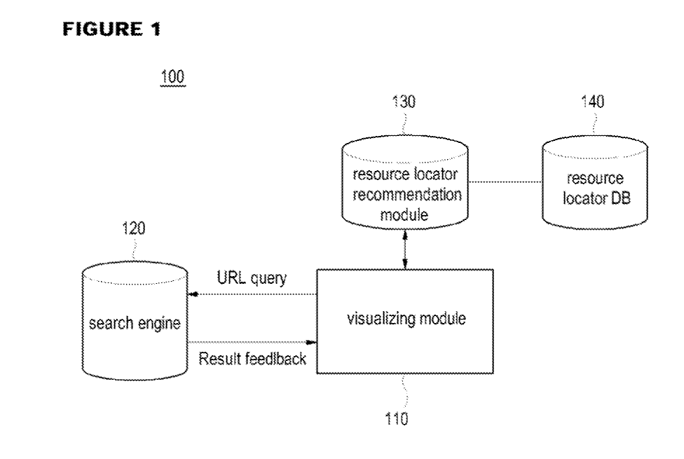

FIG. 1 shows a configuration of a resource exploring system in accordance with one embodiment of the present invention. Referring to FIG. 1, a resource exploring system 100 includes a visualization module 110 for receiving a search query including information on a target resource locator from a user and visualizing a list of search results in response to the search query, and a search engine 120 for searching for resources citing or linked to the target resource locator, which are connected to each other via a communication network.

A user may desire to search for resources such as web sites which have links to a particular resource such as web pages or blogs managed by the user. The user may operate a web browser application, or some other types of Internet-enabled or Web-enabled applications to perform such search jobs from the visualization module 110. The user inputs a search query into the visualization module 110, which sends the search query to the search engine 120 in an appropriate format, such as a HTTP message. The search query may include a target resource locator. The target resource locator may be an URL (Universal Resource Locator) address of a target resource such as a web page or a blog site managed by the user, or any other types of locators or network addresses of a particular resource. Alternatively, the search query may include keyword(s) relevant to the target resource. In such case, the visualization module 110 may determine a target resource locator based on the keyword, e.g., by searching for a list of candidate resource locators relevant to the keyword.

In one embodiment, as shown in FIG. 1, the resource exploring system 100 further includes a resource locator recommendation module 130 for the purpose of searching for a list of candidate resource locators relevant to the keyword. The resource locator recommendation module 130 generates a list of candidate resource locators (e.g., URL addresses) in response to a search query received from the visualization module 110. Any suitable keyword searching methods may be employed in recommending such a list of candidate resource locators. In a particular embodiment, the resource locator recommendation module 130 is connected to a resource locator database (DB) 140 in which a plurality of resource locators are stored with one or more corresponding search keywords. For example, when a user inputs a search query including one or more keywords relevant to a target resource locator, the visualization module 110 forwards the search query to the resource locator recommendation module 130, which performs syntax analysis on the search query to extract one or more keywords and retrieves a list of candidate resource locators for the target resource locator. The resource locator recommendation module 130 then sends the retrieved list of candidate resource locators to the visualization module 110, which displays the list such that a user can select one of the candidate resource locators as the target resource locator.

Upon receiving the target resource locator from the visualization module 110, the search engine 120 search resources each having at least one link to the target resource locator, and returns the searched resources to the visualization module 110. In one embodiment, the search engine 120 may be a site exploring module such as the Site Explorer provided by Yahoo! Inc.

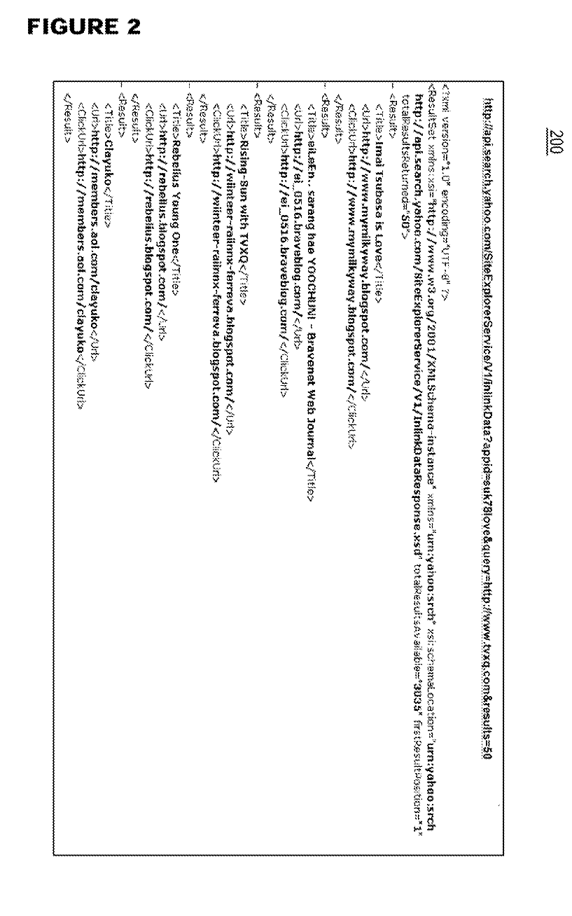

FIG. 2 shows one example of search results transferred from the search engine 120 to the visualization module 110. As shown in FIG. 2, the search results may be represented in a format of an Extensible Markup Language (XML) document 200. The document 200 includes information on resources having links to the target resource locator. For example, as illustrated in FIG. 2, the document 200 has an XML declaration section and a result section. The XML declaration section of the XML document 200 includes a tag such as “<?xml version=“1.0”encoding=“UTF-8”?>, which defines the XML version and the encoding method used in the document. The result section is provided below the XML declaration section of the XML document 200 and provides information of the search results such as resources having links to the target resource locator. The information includes a title, a URL, a click URL of the respective search result. The order of the search results listed in the document 200 may be determined based on the number of links to the target resource locator. That is, a resource having more links to the target resource locator is ranked higher in the list. For instance, with reference to FIG. 2, a resource titled “Imai Tsubasa is Love” has a higher rank than a resource titled “eiLeEn . . . sarand hai YOOCHUN!—Bravenet Web Journal.”

In response to a list of search results received from the search engine 120, the visualization module 110 performs a visualization of the search results. The visualization of the search results may be performed using any suitable graphic rendering methods. Also, the visualization of the search results may be represented in a tree data structure including a hierarchy of nodes.

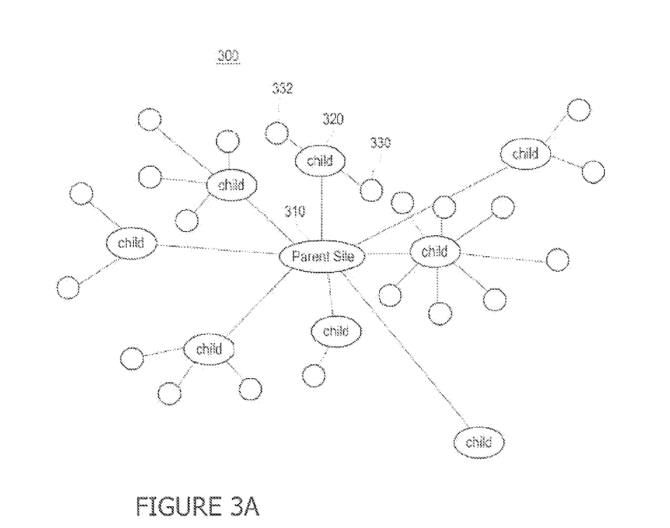

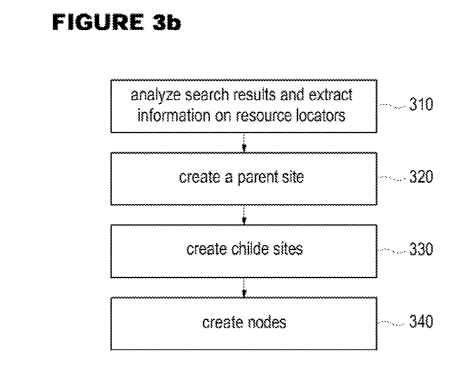

FIG. 3A shows an example of a tree data structure 300 representing search results, i.e., resources having links to a target resource locator. The tree data structure 300 shown in FIG. 3A conceptually illustrates a hierarchy of nodes representing a target resource locator and its associated search results obtained by the search engine. As shown in FIG. 3A, a tree data structure 300 includes a parent site 310 and one or more child sites 320, each linked to one or more nodes 330 and 332. While the patent site 310 indicates a target resource locator, the child site 320 indicates a network addressable resource such as a web site or domain that includes one or more resources having a link to the target resource locator. Further, a link between the parent site 310 and the child site represents a link or a citation from one resource to another resource. The child sites 320 may have one or more associated resources, which are represented as nodes 330 and 332.

For example, if a user inputs a target resource locator such as “www.tvxq.com” into the visualization module 110, then the search engine 120 outputs a list of search results including a website or domain such as “http://mymilkyway.blogspot.com” which includes resources such as web pages (e.g., “2004_{—}07_{—}01_mymilkyway_archive.html,” “2005_{—}09_{—}01_mymilkyway_archive.html,” and “2004_{—}12_{—}01_mymilkyway_archive.html”). Then, the visualization module 110 generates a visualization of the search results, i.e., a tree structure including a parent site corresponding to the target resource locator “www.tvxq.com”, which is linked to a child site corresponding to the website or domain” http://mymilkyway.blogspot.com.” In the tree structure, the child site is linked to three nodes corresponding to the resources or web pages (“2004_{—}07_{—}01_mymilkyway_archive.html,” “2005_{—}09_{—}01_mymilkyway_archive.html,” “2004_{—}12_{—}01_mymilkyway_archive html”) of the website or domain.

FIG. 3B illustrates an example process for generating a tree data structure based on a list of search results in accordance with one embodiment of the present invention. First, a visualization module such as visualization module 110 (FIG. 1) analyzes search results from a search engine such as search engine 120 to extract information on resource locators having links to a target resource locator (operation 310). The information on resource locators may include domain names of the resource locators and resources indicated by the resource locators. Based on the extracted information, the visualization module creates a tree structure including a parent site such as the parent site 310 corresponding to the target resource locator (operation 320), and then creates one or more child sites linked to the parent site, such as the child sites 320, corresponding to the domain names of resource locators (operation 330). Lastly, the visualization module 110 may create nodes 330 and 332 linked to the child site, corresponding to resources indicated by the resource locators (operation 340).

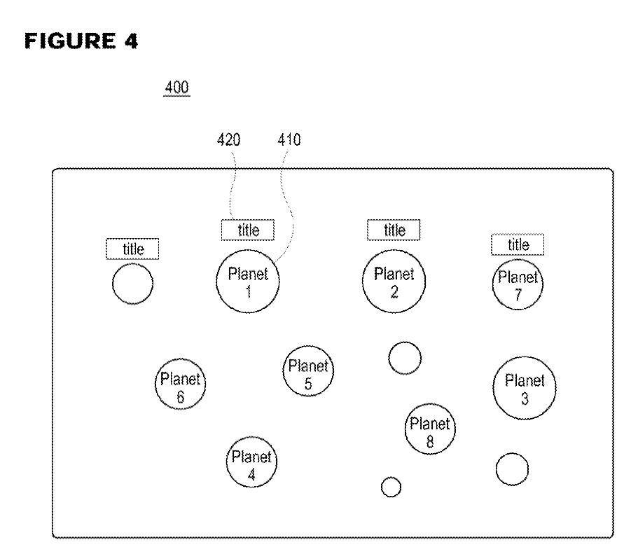

In one particular embodiment, the representation of the search results outputted from the search engine 120 includes a graphic representation of a tree data structure (hereinafter referred to as a “constellation map”). that is, the tree data structure generated by the visualization module 110 may be converted into various graphic representations for display. FIG. 4 illustrates an example of a graphic representation 400 (hereinafter referred to as “constellation map) of search results which are rendered by the visualization module 110. In this embodiment, a resource locator in the search results, which is linked to a target resource locator is represented as a planet 410 with brief information for the resource locator, for example a title 410 of the resource locator represented by the planet 410. The size of each planet 410 on the constellation map 400 may be determined based on the number of links that the corresponding resource locator has to the target resource locator. That is, a resource locator having more links (or more resources having links) to the target resource locator is represented by a larger planet. Referring to the data structure shown in FIG. 3A, the child site having more nodes (corresponding to resources having links to a target resource locator) is represented by a larger planet.

As shown in FIG. 4, for example, a resource represented by planet 1 have more links to the target resource locator than the one represented by planet 6. Therefore, a user can easily recognize the relevancy of search results to a search query, i.e., how many times each search result (or resource indicated by the search result) refers to or cites a target resource locator related to the search query. In one embodiment, planets may be positioned in the constellation map 400 based on relevancy, i.e., the links between them. In particular, planets having more links to each other are positioned closer than the other planets on the constellation map 400.

In one embodiment, planets 410 on the constellation map 400 are differently represented depending on their attributes such as domains of the search results. That is, planets 410 may be represented with different colors depending on the domains of the corresponding resources. For example, planets 410 for resources located in the U.S. may be represented in blue, whereas planets 410 for resources located in the foreign countries except the United States may be represented in yellow. It should be noted that the method of representing planets 410 on the constellation map 400 is not limited thereto, but any other attributes (e.g., shapes or any other visual and/or auditory effects) of planets can be represented differently depending on the attributes of the corresponding resources.

In one embodiment, the graphical representation of the search results as the constellation map may be implemented using a data structure separated from the tree data structure, which includes a list of nodes corresponding to planets, each storing information on attributes such as the size, color and shape of a planet. Alternatively, information on the attributes of the planets may be stored in the tree data structure representing the search results. In such embodiment, the child sites of the tree data structure include the information on the attributes of planets representing corresponding resource locators.

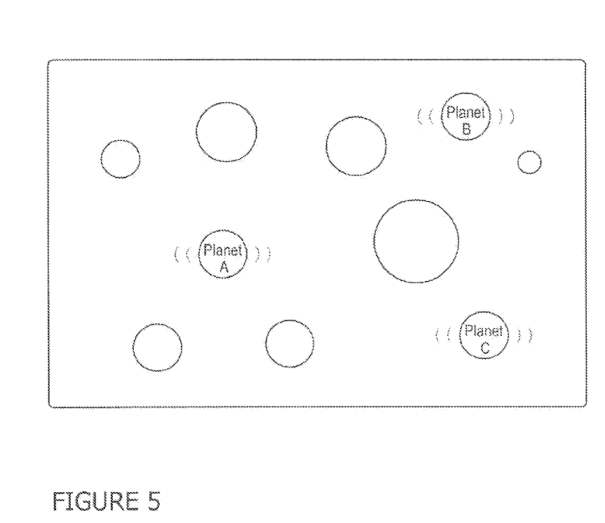

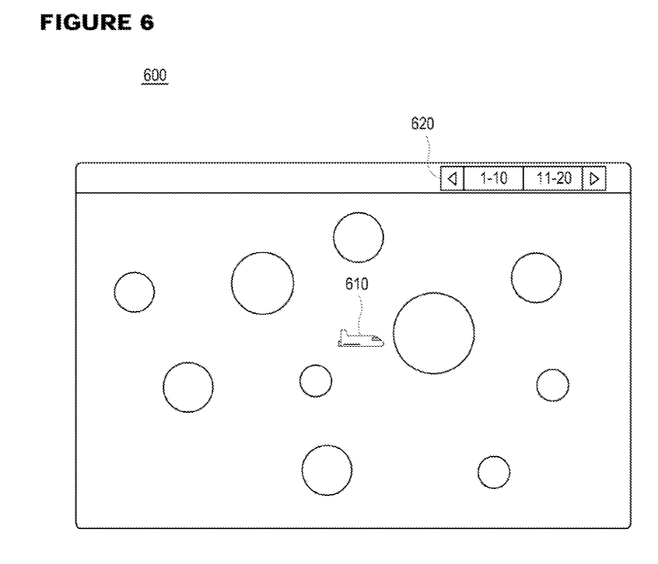

In another embodiment, if a user places a pointer or clicks on any one of planets on the constellation map, the other planets having the same or similar attributes with the pointed planet may be represented with the same shapes. FIG. 5 describes an example of such visual effects which provide a user with information on planets having the same attributes. Assuming that planets A, B and C have the same Country Code Top Level Domain, when a user clicks the planet A, the planets A, B and C are represented with animated waves surrounding them. Further, in response to clicking one of planets on the constellation map 400, the visualization module 110 may display contents or summary information of a resource corresponding to the clicked planet. Meanwhile, the number of planets displayed on a constellation map may be limited to a certain number. Accordingly, a user interface may be provided in a display screen to explore other sets of planets representing search results which are not displayed on the constellation map. As illustrated in FIG. 6, the visualization module 110 may provide a user interface 600 showing a constellation map including the first 10 planets whose rankings based on the number of links to a target resource locator range from 1^{st} to 10^{th}. Then, if a user wants to explore the next 10 planets whose rankings range from 11^{th} to 20^{th}, the user may click a right arrow button on a tool bar 620.

In one embodiment, in order to provide a user with interstellar exploration experience, the visualization module 110 may represent a pointer of a pointing device (e.g., mouse) with a little space ship 610 that flies between the planets. If a user clicks one planet using the pointer, the visualization module 110 provides a small viewer window including information such as a resource locator and an image representing a corresponding resource.

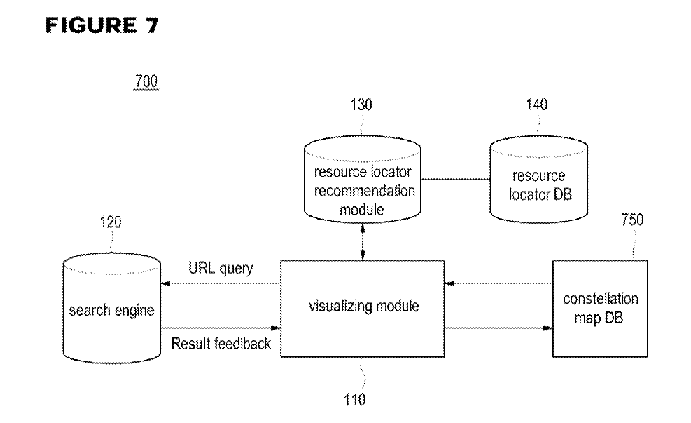

According to one embodiment, the visualization module 110 provides a function of managing the tree data structure representing the search results and/or its graphical representation such as a constellation map. In particular, the data structure and/or its graphical representation generated by the visualization module 110 may be stored in a database for later retrieval and modification. FIG. 7 shows a configuration of a resource exploring system 700 including a database for storing generated data structure. Upon receiving a search query including a particular target resource locator, a visualization module 110 generates a tree structure and its graphical representation, i.e., a constellation map, as explained above with reference to FIG. 1, which is stored in a constellation map database (DB) 750. Then, a user may later retrieve and modify the stored data structure and/or its graphical representation. Also, the stored data structure and/or its graphical representation may be provided to other users who input the same search query in the visualization module 110.

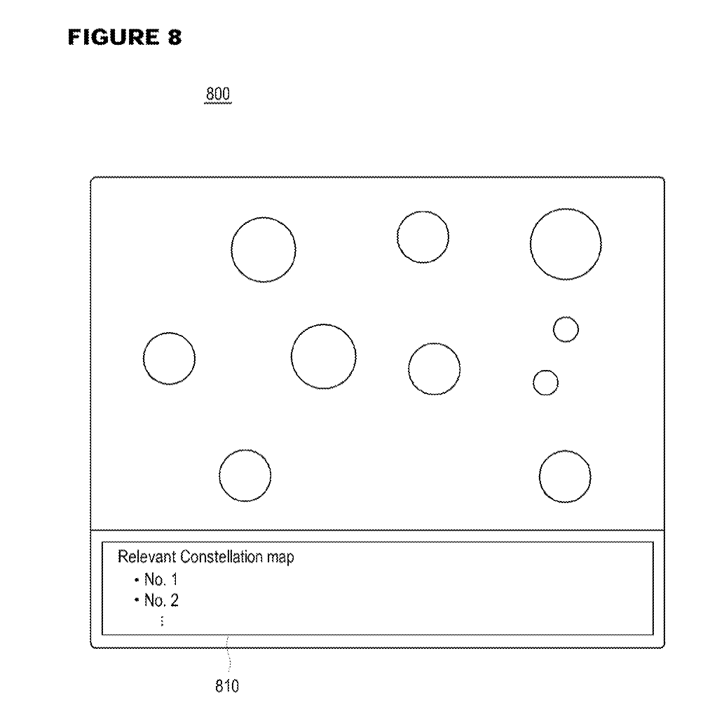

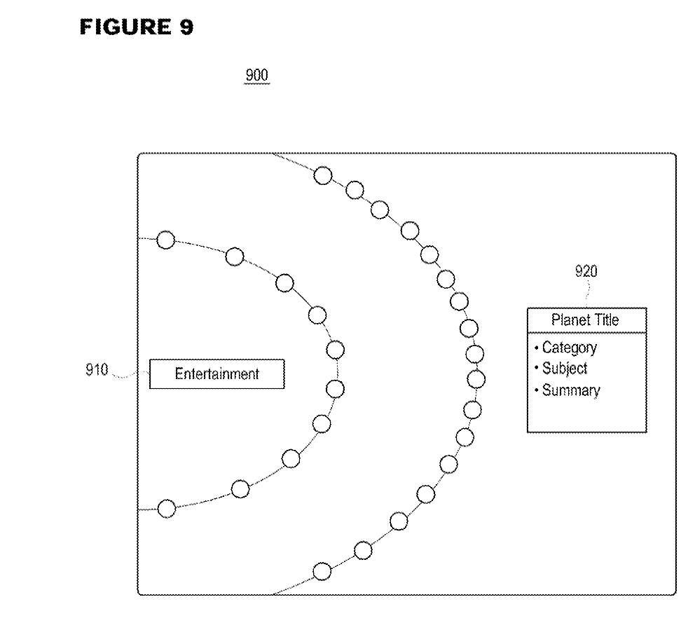

FIG. 8 describes an example of a graphical user interface 800 showing a constellation map together with a list box 810 showing relevant constellation maps already saved in the constellation map DB 750. If a user selects one of the relevant constellation maps in the list box 810, the user interface 800 may display the selected constellation map using a graphical user interface 900, as shown in FIG. 9. As illustrated in FIG. 9, a category 910 of the selected constellation map may be indicated on the user interface 900. Further, if a user clicks one of planets on the constellation map, a viewer window 920 may be displayed for showing such information as the category, subject and summary of the planet. The user may modify and/or store the displayed constellation map for later retrieval.

While the methods of the present invention have been described above with reference to specific embodiments, some or all of the elements or operations thereof may be implemented using a computer system having a general purpose hardware architecture. FIG. 8 illustrates an example computing system architecture, which may be used to implement one or more of the operations described herein. In one implementation, hardware system 1000 comprises a processor 1010, a cache memory 1015, and one or more software applications and drivers directed to the functions described herein.

Additionally, hardware system 1000 includes a high performance input/output (I/O) bus 1040 and a standard I/O bus 1070. A host bridge 1020 couples processor 1010 to high performance I/O bus 1040, whereas I/O bus bridge 1050 couples the two buses 1040 and 1070 to each other. A system memory 1060 and a network/communication interface 1030 are coupled to bus 1040. Hardware system 1000 may further include video memory (not shown) and a display device coupled to the video memory. Mass storage 1030 and I/O ports 1090 are coupled to bus 1070. Hardware system 1000 may optionally include a keyboard and pointing device, and a display device (not shown) coupled to bus 1070. Collectively, these elements are intended to represent a broad category of computer hardware systems, including but not limited to general purpose computer systems based on the Pentium® processor manufactured by Intel Corporation of Santa Clara, Calif., as well as any other suitable processor.

The elements of hardware system 1000 are described in greater detail below. In particular, network interface 1030 provides communication between hardware system 1000 and any of a wide range of networks, such as an Ethernet (e.g., IEEE 802.3) network, etc. In the case of the resource exploring system 100, the network interface 1030 interfaces between the hardware system 1000 and the network for allowing the hardware system 1000 to manage those databases. Mass storage 1030 provides permanent storage for the data and programming instructions to perform the above described functions implemented in the resource exploring system 100, whereas a system memory 1060 (e.g., DRAM) provides temporary storage for the data and programming instructions when executed by processor 1010. I/O ports 1090 are one or more serial and/or parallel communication ports that provide communication between additional peripheral devices, which may be coupled to hardware system 1000.

Hardware system 1000 may include a variety of system architectures, and various components of hardware system 1000 may be rearranged. For example, cache 1015 may be on-chip with processor 1010. Alternatively, cache 1015 and processor 1010 may be packed together as a “processor module,” with processor 1010 being referred to as the “processor core.” Furthermore, certain implementations of the present invention may not require nor include all of the above components. For example, the peripheral devices shown coupled to standard I/O bus 1070 may couple to high performance I/O bus 1040. In addition, in some implementations only a single bus may exist, with the components of hardware system 1000 being coupled to the single bus. Furthermore, hardware system 1000 may include additional components, such as additional processors, storage devices, or memories. As described below, in one embodiment, the operations of the integrated search system described herein are implemented as a series of software routines run by hardware system 1000. These software routines comprise a plurality or series of instructions to be executed by a processor in a hardware system, such as processor 1010. Initially, the series of instructions are stored on a storage device, such as mass storage 1030. However, the series of instructions can be stored on any suitable storage medium, such as a diskette, CD-ROM, ROM, EEPROMm etc. Furthermore, the series of instructions need not be stored locally, and could be received from a remote storage device, such as a server on a network, via network/communication interface 1030. The instructions are copied from the storage device, such as mass storage 1080, into memory 1060 and then accessed and executed by processor 1010.

An operating system manages and controls the operation of hardware system 1000, including the input and output of data to and from software applications (not shown). The operating system provides an interface between the software applications being executed on the system and the hardware components of the system. According to one embodiment of the present invention, the operating system is the Windows® 95/98/NT/XP operating system, available from Microsoft Corporation of Redmond, Wash. However, the present invention may be used with other suitable operating systems, such as the Apple Macintosh Operating System, available from Apple Computer Inc. of Cupertino, Calif., UNIX operating systems, LINUX operating systems, and the like.

Further, while the present invention has been shown and described with respect to a preferred embodiment, those skilled in the art will recognize that various changes and modifications may be made without departing from the spirit and scope of the invention as defined in the appended claims.

What is claimed is:

1. A method for representing an exploration of resources over a communication network, comprising:
receiving a search query representing a target resource locator form a user;
searching resources each having a link to the target resource locator; and
generating a data structure including modes representing the resources each having a link to the target resource locator.

2. The method of claim 1, further comprising:
presenting a list of candidate resource locator to the user, wherein the list of candidate resource locators are generated based on the search query; and
selecting one of the candidate resource locators as the target resource locator.

3. The method of claim 1, wherein the data structure includes a parent node corresponding to the target resource locator and one of more child nodes, which are linked to the parent node, corresponding to the resources each having a link to the target resource locator.

4. The method of claim 3, further comprising:
converting the data structure into a graphical representation of the resources each having a link to the target resource locator wherein the graphical representation includes a constellation map including a plurality of planets representing the child nodes.

5. The method of claim 4, wherein the sizes of the planets are proportional to the numbers of links to the target resource locator that corresponding resources have.

6. The method of claim 4, wherein the planets are represented using different colors or shapes depending on one or more attributes of the corresponding resources.

7. The method of claim 6, wherein the attributes include network domains where the corresponding resources are located, wherein the planets representing the resources located in a same domain are represented using same colors or shapes.

8. The method of claim 4, further comprising:
in response to the user's clicking one of the planets, displaying a content of a resource corresponding to the clicked planet.

9. The method of claim 1, further comprising:
storing the data structure including nodes representing the resources each having a link to the target resource locator.

10. Logic encoded in one of more tangible media, the logic, when executed, operable to cause one or more processors to:
receive a search query representing a target resource locator from a user;
search resources each having a link to the target resource locator; and
generate a data structure including nodes representing the resources each having a link to the target resource locator.

11. A system for representing an exploration of resources over a communication network, comprising:
a visualization module configured to receive a search query representing a target resource locator from a user; and
a search engine configured to search resources each having a link to the target resource locator,
wherein the visualization module is configured to generate a data structure including nodes representing the resources each having a link to the target resource locator.

12. The system of claim 11, further comprising:
a resource locator recommendation module configured to generate a list of candidate resource locators based on the search query and provide the list of candidate resource locators to the visualization module,
wherein if the user selects one of the candidate resource locators as the target resource locator, the visualization module transmits the selected resource locator to the search engine.

13. The system of claim 11, wherein the data structure includes a parent node corresponding to the target resource locator and one or more child nodes, which are linked to the parent node, corresponding to the resources each having a link to the target resource locator.

14. The system of claim 13, wherein the visualization module is further configured to convert the data structure into a graphical representation of the resources each having a link to the target resource locator, wherein the graphical representation includes a constellation map including a plurality of planets representing the child nodes.

15. The system of claim 14, wherein the sizes of the planets are proportional to the numbers of links to the target resource locator that corresponding resources have.

16. The system of claim 14, wherein the planets are represented using different colors or shapes depending on one or more attributes of the corresponding resources.

17. The system of claim 16, wherein the attributes include network domains where the corresponding resources are located, wherein the planets representing the resources located in a same domain are represented using same colors or shapes.

18. The system of claim 14, wherein in response to the user's clicking one of the planets, the visualization module displays a content of a resource corresponding to the clicked planet.

19. The system of claim 11, further comprising:
a database configured to store the data structure including nodes representing the resources each having a link to the target resource locator. _
